(19) United States
(12) Patent Application Publication
(10) Pub. No.: US 2010/0051457 A1
(43) Pub. Date: Mar. 4, 2010

(54) PLANAR INTEGRATED ION SENSOR

(75) Inventors: Hsiung HSIAO, Zhubei City (TW); Kuo-Tong MA, Zhubei City (TW)

Correspondence Address: PATENTTM.US, P. O. BOX 82788, PORTLAND, OR, 97282-0788, US

(73) Assignee: MIDDLELAND SENSING TECHNOLOGY INC., Zhubei City (TW)

(21) Appl. No.: 12/548,016

(22) Filed: Aug. 26, 2009

(30) Foreign Application Priority Data
Sep. 3, 2008 (TW) 097133693

(51) Int. Cl. G01N 27/26

(52) U.S. Cl. 204/412

(57) ABSTRACT

A planar integrated ion sensor has a planar substrate, a working electrode assembly, a reference electrode assembly and an exchange junction. The working electrode assembly is mounted on one surface of the planar substrate and has an ion selective electrode, a working conductor electrically coupled with the ion selective electrode and a working barrier partially covering the ion selective electrode and the working conductor. The reference electrode assembly has a reference electrode, a reference conductor electrically coupled with the reference electrode, a reference barrier partially covering the reference electrode and the reference conductor and a hood with an inner space filled with electrolyte. The exchange junction allows communication between a liquid sample and the electrolyte in the inner space of the hood. The present invention has a decreased volume, is easily portable and is convenient for an operator to determine ion concentration in the liquid sample without incorporating other device.

### BACKGROUND OF THE INVENTION

1. Field of Invention

The present invention relates to a planar integrated ion sensor, and more particularly to a planar integrated ion sensor with a planar structure having a working electrode and a reference electrode both attached to a planar substrate, such that the planar integrated ion sensor has a decreased size and is easy and convenient to operate.

2. Description of the Related Art

Voltage analysis method is used to measure a potential generated by dissociative ions in liquid sample for determining ion concentration in the liquid sample and further for evaluating pH value in the liquid sample. Voltage analysis method requires two electrodes including a reference electrode and a working electrode (i.e. indicator electrode). The reference electrode has a stable, constant and known electrode potential, so it is used as a reference. The reference electrode conducts a reversible reaction to rapidly achieve thermal equilibrium state, so it provides a stable potential that can be detected. Generally, the reference electrode comprises calomel electrode and a Ag/AgCl electrode. The Ag/AgCl electrode can be used at higher than 60° C., so it is more beneficial than the calomel electrode and is preferred. The reference electrode, the working electrode and dissociative ions in liquid sample become a circuit. A potential difference can be measured and pH value can be evaluated according to the potential difference.

With reference to FIG. 6, a conventional ion sensor with glass electrode comprises a reference electrode tube (41), a working electrode tube (42) and a display (43). The reference electrode (41) is filled with conductive KCl liquid (412) and has an end, a liquid junction (411) and a calomel electrode or a Ag/AgCl reference electrode (413). The liquid junction (411) is formed at the end of the reference electrode (41) and may be made of porous ceramic material. The calomel or the Ag/AgCl reference electrode is formed in the reference electrode (41) and is surrounded by KCl liquid (412). The working electrode (42) is also called a glass electrode, is covered with a protective layer (421), is filled with KCl liquid (423) and has an end, a glass bubble (422) and a working AgCl electrode (424). The glass bubble (422) protrudes from the end of the working electrode (42) and is made to be as thin as possible. The working AgCl electrode (424) is mounted in the glass bubble (422). The display (43) connects the reference electrode (41) with the working electrode (42) and presents a potential difference.

However, the conventional ion sensor with glass electrode is large and the glass bubble (422) of the working electrode (42) is fragile. Furthermore, an operator has to prevent a surface of the glass bubble (422) from being contaminated by oil or dirt and from being scratched, such that a sensibility of the glass bubble (422) and accuracy of measured value can be reliably retained. Therefore, the conventional ion sensor with glass electrode is inconvenient.

With reference to FIG. 7, U.S. Pat. No. 4,857,166 discloses an ion sensor comprising a sensing casing (50) and a detector (60). The sensing casing (50) has a body (51) and a tongue (52). The body (51) has a reference electrode (53) and a working electrode (54). The reference electrode (53) and the working electrode (54) stretch from the body (51) to a surface of the tongue (52). Some drops of liquid sample can be dropped on the reference electrode (53) and the working electrode (54) to form a circuit. The detector has a slot (61), a circuit board and a display (62). The slot (61) is formed in the detector and receives the tongue (52) of the sensing casing (50) for detecting the reference electrode (53) and the working electrode (54). The circuit board is mounted in the detector (60) for electrically coupling to the reference electrode (53) and the working electrode (54) when the tongue (52) is inserted into the slot (61). The display (62) shows a result detected and calculated by the circuit.

However, such ion detector cannot be put into a liquid sample directly and an operator has to drop some liquid sample on the reference electrode (53) and the working electrode (54). Therefore, some liquid sample is consumed during detection. Furthermore, the body (51) of the sensing casing (50) is required to receive the liquid sample, so the body (51) has a specific size limit to prevent the body (51) from receiving insufficient amount of liquid sample, which results in inaccurate measured value.

With reference to FIG. 8, U.S. Pat. No. 6,964,734 discloses a planar reference electrode comprising a plate (70), an electrode connection (71), an insulating membrane (72), an electrode (73), a protecting membrane (74) and a junction (76). The electrode connection (71) is mounted on the plate (70) near one end of the plate (70). The insulating membrane (72) is covered on the electrode connection (71) to expose an end of the electrode connection (71). The electrode (73) is mounted on the plate (70) near one end of the plate (70) and contacts the electrode connection (71). The protecting membrane (74) is semi-spherical, is made of porous polymer, is filled with electrolyte (75) and covers the electrode (73). The junction (76) is mounted on the plate (70) near one end of the plate (70) opposite to electrode connection (71). Therefore, the planar reference electrode has a reduced size, which is easy to carry and transport.

However, it is only a reference electrode. An additional working electrode is required during detection. Furthermore, the electrolyte (75) is only filled in the spherical protecting membrane (74), so the electrolyte (75) may be insufficient, which also results in inaccurate measured value.

To overcome the shortcomings, the present invention provides a planar integrated ion sensor to mitigate or obviate the aforementioned.

### SUMMARY OF THE INVENTION

The primary objective of the present invention is to provide a planar integrated ion sensor having a planar structure with a decreased size so is easy and convenient user to operate.

To achieve the objective, the planar integrated ion sensor in accordance with the present invention comprises a planar substrate, a working electrode assembly, a reference electrode assembly and an exchange junction. The working electrode assembly is mounted on one surface of the planar substrate and has an ion selective electrode, a working conductor and a working barrier. The working conductor is electrically coupled with the ion selective electrode. The working barrier partially covers the ion selective electrode and the working conductor. The reference electrode assembly has a reference electrode, a reference conductor, a reference barrier and a hood. The reference conductor is electrically coupled with the reference electrode. The reference barrier partially covers the reference electrode and the reference conductor. The hood covers the reference electrode, the reference conductor and the reference barrier and has an inner space filled with electrolyte. The exchange junction communicates with the inner space in the hood containing electrolyte.

The present invention has a decreased volume, is easily portable and is convenient for an operator to determine ion concentration in the liquid sample without incorporating another device.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a planar integrated ion sensor in of one embodiment in accordance with the present invention with an exchange junction formed through a hood;

FIG. 2 is a perspective view of a working electrode assembly of the planar integrated ion sensor in FIG. 1;

FIG. 3 is a cross sectional side view of a planar integrated ion sensor in of one embodiment in accordance with the present invention with an exchange junction formed through a planar substrate;

FIG. 4 is a perspective view of a working electrode assembly of the planar integrated ion sensor in FIG. 3;

FIG. 5 is an upper view of a planar integrated ion sensor of another embodiment in accordance with the present invention;

FIG. 6 shows a conventional ion sensor with glass electrode in accordance with the prior art;

FIG. 7 is a perspective view of a conventional ion sensor with glass electrode and a detector in accordance with the prior art; and

FIG. 8 is a cross sectional side view of a conventional planar reference electrode in accordance with the prior art.

### DETAILED DESCRIPTION OF THE INVENTION

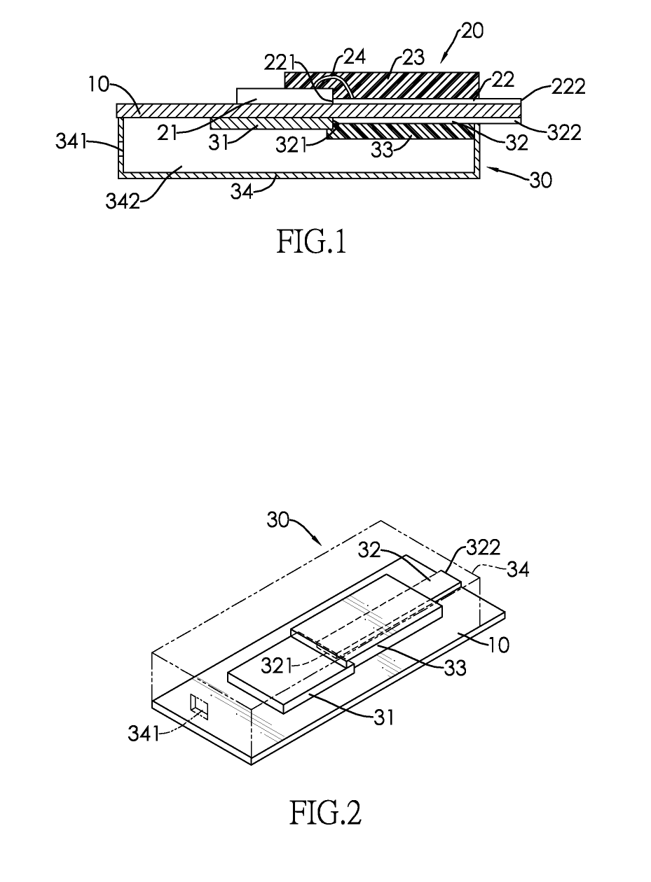

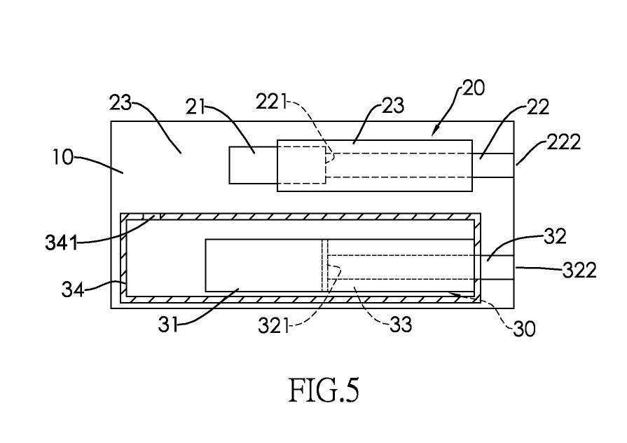

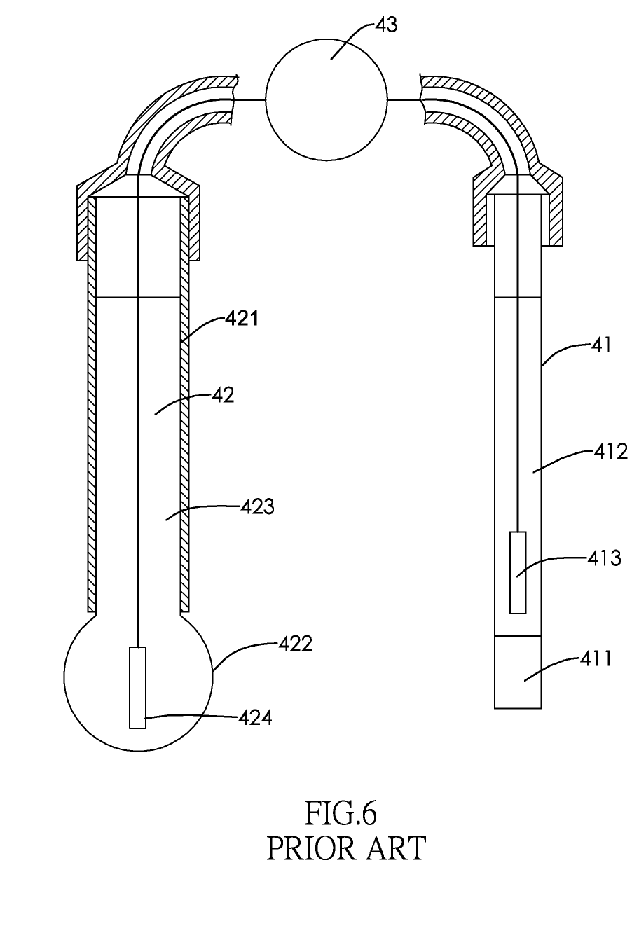

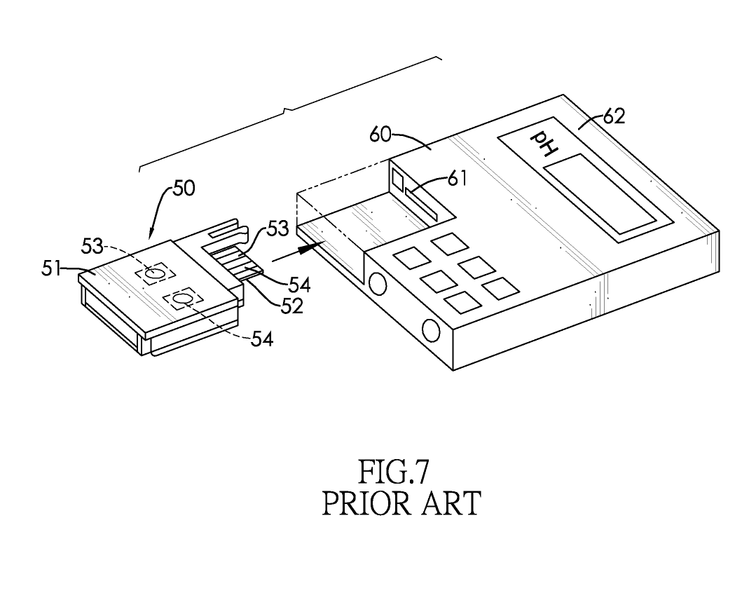

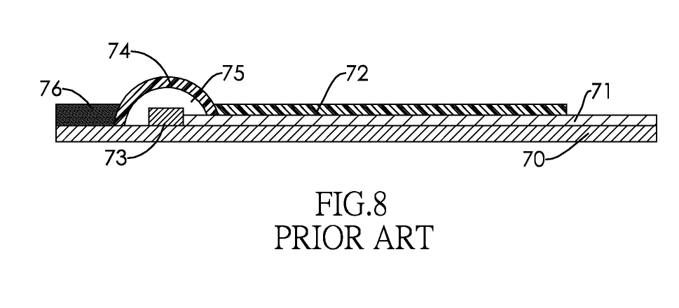

With reference to FIGS. 1 and 4, a planar integrated ion sensor in accordance with the present invention has a planar substrate (10), a working electrode assembly (20), a reference electrode assembly (30) and an exchange junction (341, 343).

The planar substrate (10) has a first surface and a second surface opposite to the first surface.

With further reference to FIG. 2, the working electrode assembly (20) is mounted on one surface of the planar substrate (10) and has an ion selective electrode (21), a working conductor (22) and a working barrier (23). The ion selective electrode (21) is mounted on the surface of the planar substrate (10) and may be ion-sensitive field effect transistor (ISFET), extended gate field effect transistor (EGFET), indium tin oxide (ITO) wafer or tin oxide (TiO₂). The working conductor (22) is mounted on the surface of the planar substrate adjacent to the ion selective electrode (21), is electrically coupled with the ion selective electrode (21), can be detected by a detector and has a proximal end (221) and a distal end (222). The working conductor (22) is made of conductive metal such as silver (Ag), copper (Cu), gold (Au), aluminum (Al) or an alloy thereof or semiconductive material such as polycrystalline silicon, carbon, indium tin oxide (ITO) or the like. The proximal end (221) of the working conductor (22) electrically connects to the ion selective electrode (21) by a conductive material (24). The conductive material (24) may be conductive gel, conductive tape or materials for wire bonding such as aluminum (Al), copper (Cu), gold (Au), silver (Ag) or the like. The working barrier (23) partially covers the ion selective electrode (21) and the working conductor (22) to protect the ion selective electrode (21) and the working conductor (22), which allows the ion selective electrode (21) to be partially exposed to contact with liquid sample when used and also allows the distal end (222) of the working conductor (22) to be detected by the detector. The working barrier (23) is made of non-conductive material such as epoxy or UV-cured adhesive or semiconductive material such as silicon dioxide (SiO₂) or silicon nitride (SiN). The working barrier (23) ensures that a signal generated by the ion selective electrode (21) after contacting with the liquid sample transfers to the distal end (222) of the working conductor (22) via the conductive material (24).

The reference electrode assembly (30) is mounted on one surface of the planar substrate (10) and has a reference electrode (31), a reference conductor (32), a reference barrier (33) and a hood (34). The reference electrode (31) may be a AgCl electrode and is mounted on the surface of the planar substrate (10). The reference conductor (32) is mounted on the surface of the planar substrate (10), is electrically coupled with the reference electrode (31), can be detected by the detector and has a proximal end (321) and a distal end (322). The proximal end (321) of the reference conductor (32) directly abuts the reference electrode (31). The reference conductor (32) is made of conductive metal such as silver, copper, gold, aluminum or an alloy thereof or semiconductive material such as polycrystalline silicon, carbon, indium tin oxide (ITO) or the like. The reference barrier (33) partially covers the reference electrode (31) and the reference conductor (32) to protect the reference electrode (31) and the reference conductor (32), which allows the reference electrode (31) to be partially exposed to contact with a liquid sample when used and also allows the distal end (322) of the reference conductor (32) to correspond to the distal end (222) of the working conductor (22) and to be detected by the detector. The reference barrier (33) is made of non-conductive material such as epoxy or UV-cured adhesive or semiconductive material such as silicon dioxide (SiO₂) or silicon nitride (SiN). The hood (34) is mounted on the surface of the planar substrate (10), covers the reference electrode (31), the reference conductor (32) and the reference barrier (33) and has an inner space. The inner space is filled with KCl or HCl electrolyte or gel (342) such as agar gel containing KCl or HCl. The hood (34) may be formed integrally with the reference barrier (33). The hood (34) may be made of non-conductive material such as polymer, such as polycarbonate (PC), poly(ethylene) (PE), poly(acrylonitrile, butadiene, styrene) (ABS) or the like, or ceramic.

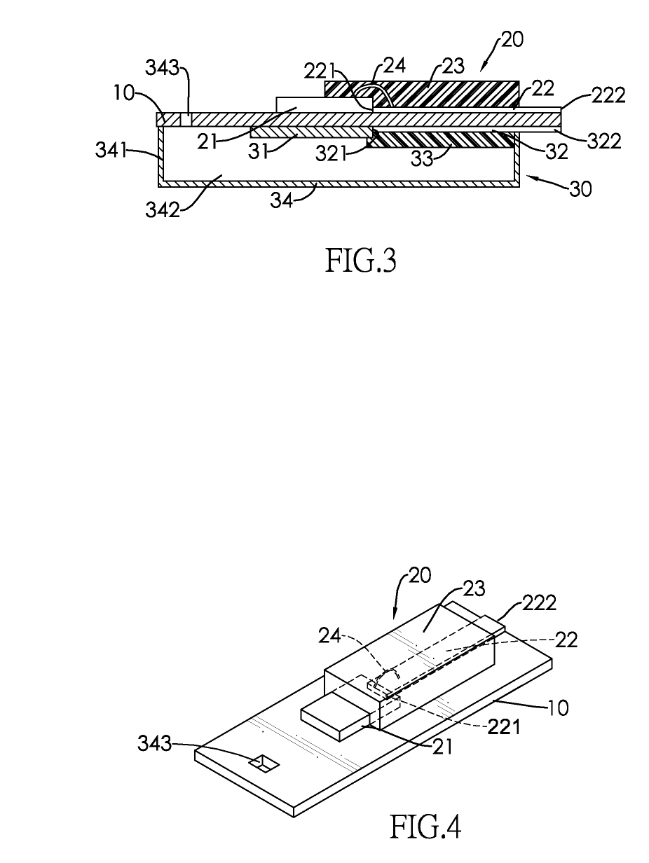

The exchange junction (341, 343) is made of porous material, allows the liquid sample to communicates with the electrolyte or gel in the hood (34) contacting the reference electrode (31). A preferred porous material has uniform pores and excellent hydrophilic property and may be porous polymer such as poly(vinyl chloride), porous ceramic such as molecular sieve, porous metal such as aluminum, porous microelectromechanical material, fiber or the like. In one aspect, the exchange junction (341) is formed through the hood (34). In another aspect, with reference to FIGS. 3 and 4, the exchange junction (343) is defined through the planar substrate (10).

In one embodiment, the working electrode assembly (20) and the reference electrode assembly (30) are respectively mounted on the first surface and the second surface of the planar substrate (10).

With reference to FIG. 5, in another embodiment, the working electrode assembly (20) and the reference electrode assembly (30) are both mounted on a same surface of the planar substrate (10), such as both on a first surface or both on a second surface.

In the present invention, the working electrode assembly (20) and the reference electrode assembly (30) are integrated on the same planar substrate (10), so the planar integrated ion sensor of the present invention has a decreased volume, is easily portable and is convenient for an operator to determine ion concentration in the liquid sample without incorporating another device.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A planar integrated ion sensor comprising:
a planar substrate having two surfaces opposite to each other;
a working electrode assembly mounted on one surface of the planar substrate and having
an ion selective electrode mounted on the surface of the planar substrate;
a working conductor mounted on the surface of the planar substrate adjacent to the ion selective electrode and electrically coupled with the ion selective electrode; and
a working barrier partially covering the ion selective electrode and the working conductor to protect the ion selective electrode and the working conductor;
a reference electrode assembly mounted on one surface of the planar substrate and having
a reference electrode mounted on the surface of the planar substrate;
a reference conductor mounted on the surface of the planar substrate and being electrically coupled with the reference electrode;
a reference barrier partially covering the reference electrode and the reference conductor to protect the reference electrode and the reference conductor; and
a hood mounted on the surface of the planar substrate, covering the reference electrode, the reference conductor and the reference barrier and having an inner space filled with electrolyte; and
an exchange junction communicating with the inner space in the hood and adapted to contain a liquid sample in the inner space.

2. The planar integrated ion sensor as claimed in claim 1, wherein the working electrode assembly and the reference electrode assembly are respectively mounted on different surfaces of the planar substrate.

3. The planar integrated ion sensor as claimed in claim 1, wherein the working electrode assembly and the reference electrode assembly are both mounted on a same surface of the planar substrate.

4. The planar integrated ion sensor as claimed in claim 1, wherein the ion selective electrode is ion-sensitive field effect transistor (ISFET), extended gate field effect transistor (EGFET), indium tin oxide (ITO) wafer or tin oxide (TiO₂).

5. The planar integrated ion sensor as claimed in claim 1, wherein
the working conductor is made of conductive metal or semiconductive material; and
the reference conductor is made of conductive metal or semiconductive material.

6. The planar integrated ion sensor as claimed in claim 5, wherein the conductive metal is selected from the group consisting of silver, copper, gold, aluminum and alloys thereof.

7. The planar integrated ion sensor as claimed in claim 5, wherein the semiconductive material is selected from the group consisting of polycrystalline silicon, carbon and indium tin oxide (ITO).

8. The planar integrated ion sensor as claimed in claim 1, wherein the working conductor electrically connects to the ion selective electrode by conductive gel, conductive tape or materials for wire bonding.

9. The planar integrated ion sensor as claimed in claim 1, wherein
the working barrier is made of non-conductive material; and
the reference barrier is made of non-conductive material.

10. The planar integrated ion sensor as claimed in claim 1, wherein the non-conductive material is epoxy or UV-cured adhesive.

11. The planar integrated ion sensor as claimed in claim 1, wherein the reference electrode is AgCl electrode.

12. The planar integrated ion sensor as claimed in claim 1, wherein the exchange junction is made of porous material.

13. The planar integrated ion sensor as claimed in claim 12, wherein the porous material is made of porous polymer, porous ceramic, porous metal, porous microelectromechanical material or fiber.

14. The planar integrated ion sensor as claimed in claim 13, wherein the porous polymer is poly(vinyl chloride).

15. The planar integrated ion sensor as claimed in claim 13, wherein the porous ceramic is a molecular sieve.

16. The planar integrated ion sensor as claimed in claim 13, wherein the porous metal is aluminum.

17. The planar integrated ion sensor as claimed in claim 1, wherein the hood is made of non-conductive material.

18. The planar integrated ion sensor as claimed in claim 1, wherein the electrolyte is KCl electrolyte.
